(19) United States
(12) Patent Application Publication
(10) Pub. No.: US 2004/0034660 A1
(43) Pub. Date: Feb. 19, 2004

(54) System and method for keyword registration

(76) Inventors: Andy Chen, Taipei (TW); Richard Lai, Taipei (TW)

Correspondence Address: RABIN & Berdo, PC, 1101 14TH STREET, NW, SUITE 500, WASHINGTON, DC, 20005, US

(21) Appl. No.: 10/340,617

(22) Filed: Jan. 13, 2003

(30) Foreign Application Priority Data
Aug. 16, 2002 (TW) 91118521

(51) Int. Cl. G06F 17/00

(52) U.S. Cl. 707/104.1

(57) ABSTRACT

A system and method for keyword registration. The system has a data storage device having a symbol database, a function word database, and a keyword database, and a processor. The processor compares a document to the symbol and function word databases to delete symbols and function words in the document, calculates the occurrence frequency of each word in the document to acquire a plurality of candidate words and corresponding frequency values, selects at least one keyword from the candidate words according to a condition, and registers the selected keyword into the keyword database.

### BACKGROUND OF THE INVENTION

1. Field of the Invention

The present invention relates to a system and method for keyword registration, and particularly to a system and method for keyword registration that automatically registers keywords appearing repeatedly in a document.

2. Description of the Related Art

Current loading of information in daily life is increasingly intense. Effective means to quickly recognize the topic of documents and classify them thereby are required for more efficient use thereof.

The topic and field of a document are always recognized by checking keywords in the document. Most conventional methods parse and register keywords manually. FIG. 1 is a schematic diagram illustrating a conventional method for keyword registration. First, a number of documents 10 are parsed (11) manually to obtain keywords 12 for each document. Thereafter, these keywords are sifted and registered manually (13) to keyword database 14.

Since conventional methods manually parse documents one by one, the parsing and registration process is complicated and time-consuming. Further, synonyms are difficult to deal with if only manual assessment is relied on.

### SUMMARY OF THE INVENTION

It is therefore an object of the present invention to provide a system and method for keyword registration that automatically registers keywords appearing repeatedly in a document, so as to save time and manpower in the parsing and registration process. Further, synonyms can be recognized automatically to improve the accuracy of the parsing and registration process.

To achieve the above objects, the present invention provides a system and method for keyword registration. According to one embodiment of the invention, the system for keyword registration includes a data storage device having a symbol database, a function word database, and a keyword database and a processor.

A document is compared to the symbol and function word databases to eliminate non-keyword elements from the document. Then, the frequency of each word in the document is calculated, thereby acquiring a plurality of candidate words and corresponding frequency values. Finally, at least one keyword is selected from the candidate words according to a condition, and the selected keyword is registered to the keyword database.

The data storage device further has a synonym database. Content is further compared to the synonym database to calculate and record synonyms in the document, followed by deletion thereof. Then, the synonyms and corresponding frequency values are stored into a synonym register. Further, the synonyms and corresponding frequency values stored in the synonym register and the candidate words and corresponding frequency values are integrated.

According to another embodiment of the invention, another method for keyword registration is provided.

First, a document is received. Then, the document is compared to a symbol database to delete symbols from the document. Then, the document is compared to a function word database to delete function words from the document.

Thereafter, the frequency of each word in the document is calculated, thereby acquiring a plurality of candidate words and corresponding frequency values. Finally, at least one keyword is selected from the candidate words according to a condition, and the selected keyword is registered to a keyword database.

Further, the document is compared to a synonym database to count, record, and delete synonyms from the document, with corresponding frequency values stored into a synonym register. Thereafter, the synonyms and corresponding frequency values stored in the synonym register are added to the candidate words and corresponding frequency values.

According to the embodiments, the condition may be a predetermined minimum frequency. The candidate keywords with corresponding frequency values larger than the minimum can be selected as keywords and registered to the keyword database. Further, the candidate keywords may be sorted according to corresponding frequency values. At this time, the condition may be a predetermined minimum ranking value. The candidate keywords above the minimum can be selected as keywords and registered to the keyword database.

### BRIEF DESCRIPTION OF THE DRAWINGS

The aforementioned objects, features and advantages of this invention will become apparent by referring to the following detailed description of the preferred embodiment with reference to the accompanying drawings, wherein:

FIG. 1 is a schematic diagram illustrating the conventional method for keyword registration;

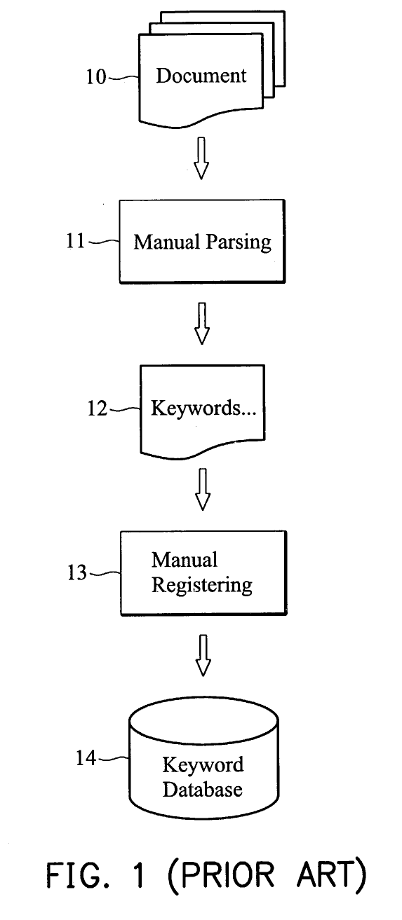

FIG. 2 is a schematic diagram showing the architecture of the system for keyword registration according to the embodiment of the present invention; and

FIG. 3 is a flowchart illustrating the operation of the method for keyword registration according to the embodiment of the present invention.

### DETAILED DESCRIPTION OF THE INVENTION

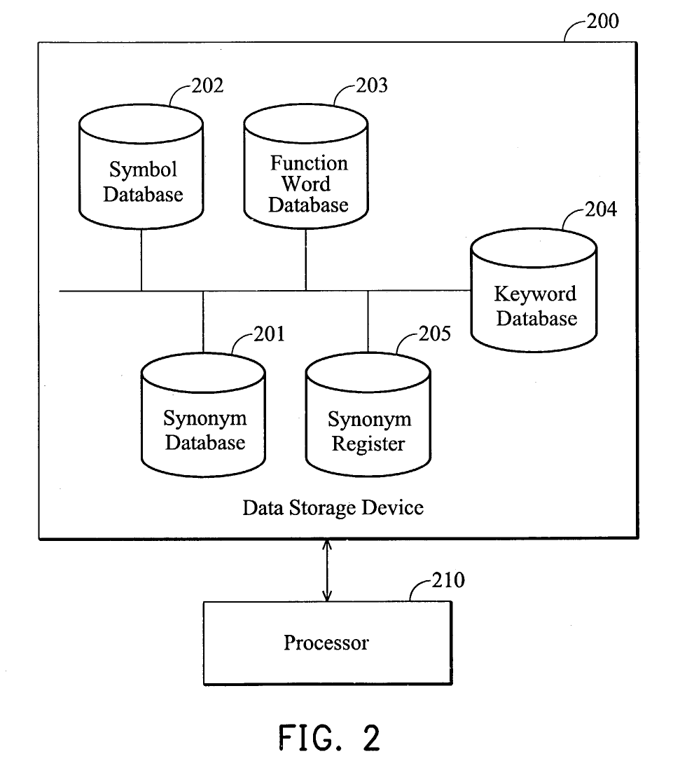

FIG. 2 is a schematic diagram showing the architecture of the system for keyword registration according to the embodiment of the present invention.

According to the embodiment of the invention, the system for keyword registration includes a data storage device 200 and a processor 210. The data storage device 200 has a synonym database 201, a symbol database 202, a function word database 203, a keyword database 204, and a synonym register 205.

The synonym database 201 records the mapping relation between synonyms, for example, “VIA tech” and “VIA Technologies, Inc” may be synonyms of “VIA”. The symbol database 202 records specific symbols, such as punctuation marks. The function word database 203 records function words, such as verbs, adjectives, adverbs, auxiliary words, or the words without meaning. For example, the function words may be “a”, “is”, “on”, and “he”. The keyword database 204 records the registered keywords.

A ready-to-manipulated document may be compared to the synonym database 201 for counting, recording, and deleting synonyms from the document by the processor 210, while the synonyms and corresponding frequency values are stored into the synonym register 205.

The document may be compared to the symbol database 202 and the function word database 203 to delete non-keyword elements from the document 210. Then, the frequency of each word in the document is calculated by the processor 210, thereby acquiring a plurality of candidate words and corresponding frequency values.

Thereafter, the synonyms and corresponding frequency values stored in the synonym register 205, and the candidate words and corresponding frequency values are integrated, which indicates that the synonyms and corresponding frequency values are added to the candidate words and corresponding frequency values.

Next, the candidate keywords may be sorted according to corresponding frequency values by the processor 210. Finally, at least one keyword is selected from the candidate words according to a condition, such as a predetermined minimum frequency (for example, the existence number is larger than 10) or a predetermined minimum ranking value (for example, top 5 ranked), and the selected keyword is registered to the keyword database 204.

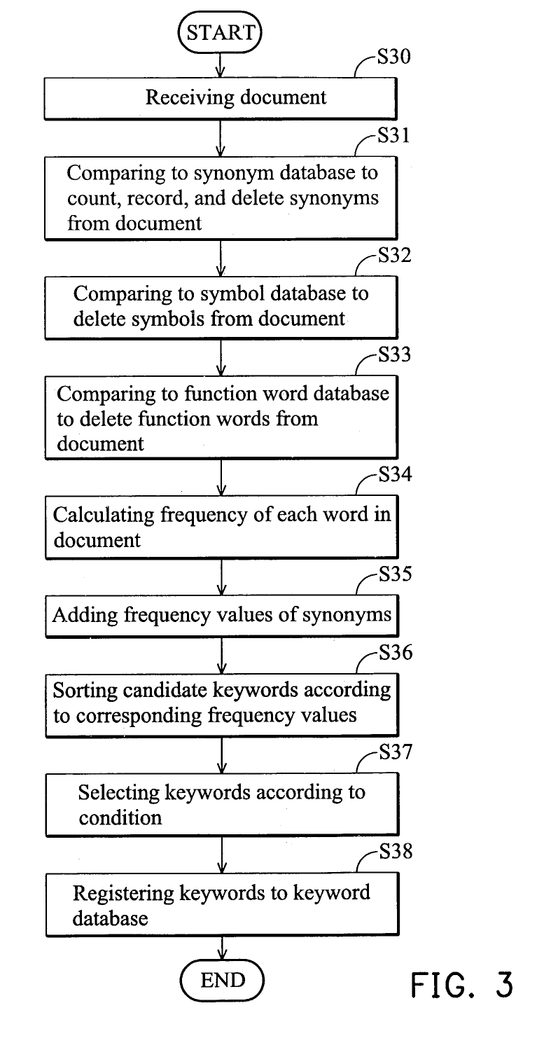

FIG. 3 is a flowchart illustrating the operation of the method for keyword registration according to the embodiment of the present invention.

First, a ready-to-manipulated document is received in step S30. Next in step S31, the document is compared to the synonym database 201 to count, record, and delete synonyms from the document, and the synonyms and corresponding frequency values are stored into the synonym register 205.

In step S32, the document is compared to the symbol database 202 to delete symbols from the document, while the document is compared to the function word database 203 to delete function words from the document in step S33. Thereafter, the frequency of each word in the document is calculated in step S34, thereby acquiring a plurality of candidate words and corresponding frequency values.

In step S35, the synonyms and corresponding frequency values stored in the synonym register are added to the candidate words and corresponding frequency values. In step S36, the candidate keywords are then sorted according to corresponding frequency values. Finally, at least one keyword is selected from the candidate words according to a condition, and the selected keyword is registered to the keyword database 204 respectively in steps S37 and S38.

The condition may be a predetermined minimum frequency or a predetermined minimum ranking value. If the condition is the predetermined minimum frequency, the candidate keywords with corresponding frequency values larger than the minimum can be selected as keywords and registered to the keyword database 204. In addition, the candidate keywords above the minimum can be selected as keywords and registered to the keyword database 204 if the condition is the predetermined minimum ranking value.

It should be noted that steps S31, S32, and S33 are independent and the sequence thereof can be changed randomly. Further, the step S36 can be omitted if the condition is the predetermined minimum frequency. Additionally, the symbol database 202 and the function word database 203 may be combined to obtain a new database recording symbols and function words to be deleted.

Next, an example with a ready-to-manipulated document is discussed as follows:

Document

The VIA C3 1 GHz processor is the coolest 1 GHz processor on the
market, saving energy and maximizing total system savings by
allowing the use of inexpensive, off-the-shelf components. The
processor runs so cool that it can operate with standard small
coolers and power supplies, making it the ideal solution for
ergonomic small footprint quiet PC designs. The first
processor in the world to be manufactured using a leading edge
0.13 micron manufacturing process, the VIA C3 1 GHz processor
has the world's smallest x86 processor die size.
VIA Technologies, Inc. is a leading innovator and developer
of PC core logic chipsets, microprocessors, and multimedia and
communications chips

The synonym database 201 includes:

Synonym Database

| | |
|---|---|
| VIA | VIATech |
| VIA | VIA Technologies, Inc. |

After the document is compared to the synonym database, the synonym, such as “VIA Technologies, Inc” is deleted, and the existence number of the synonym is calculated. Thereafter, the synonym “VIA” and corresponding frequency values are recorded into the synonym register 205. The synonym register 205 encompasses:

Synonym Register

VIA (1)

The document with synonyms deleted is shown as follows:

Document

The VIA C3 1 GHz processor is the coolest 1 GHz processor on the
market, saving energy and maximizing total system savings by
allowing the use of inexpensive, off-the-shelf components. The
processor runs so cool that it can operate with standard small
coolers and power supplies, making it the ideal solution for
ergonomic small footprint quiet PC designs. The first
processor in the world to be manufactured using a leading edge
0.13 micron manufacturing process, the VIA C3 1 GHz processor
has the world's smallest x86 processor die size.
is a leading innovator and developer of PC core
logic chipsets, microprocessors, and multimedia and
communications chips

The symbol database 202 and function word database 203 include contents as follows:

Symbol Database

| | | | |
|---|---|---|---|
| , | . | [symbol] | [symbol] |
| ; | [ | \grave{ } | ! |
| @ | # | $ | % |

Function Word Database

| | | | |
|---|---|---|---|
| A | It | This | by |
| Is | On | Are | she |
| The | He | That | I |

After comparison to the symbol database and function word database, the symbols and function words in the document are deleted. The document that the symbols and function words are deleted is shown as follows:

Document

VIA C3 1 GHz processor coolest 1 GHz processor market saving
energy and maximizing total system savings allowing use of
inexpensive off shelf components processor runs so cool can
operate with standard small coolers and power supplies making
ideal solution for ergonomic small footprint quiet PC designs
first processor in world to be manufactured using leading edge
013 micron manufacturing process VIA C3 1 GHz processor has
worlds smallest x86 processor die size
leading innovator and developer of PC
core logic chipsets microprocessors and multimedia and
communications chips

Next, the number of words in the document is calculated, thereby acquiring candidate keywords and corresponding frequency values (in the parentheses):

Candidate Keywords

| | | | |
|---|---|---|---|
| VIA (3) | C3 (2) | 1 GH (3) | processor (6) |
| coolest (1) | Viatech (1) | . . . | |

Thereafter, the synonyms and corresponding frequency values stored in the synonym register are added to the candidate words and corresponding frequency values. The updated candidate keywords follow:

Candidate Keywords

| | | | |
|---|---|---|---|
| VIA (4) | C3 (2) | 1 GH (3) | processor (6) |
| coolest (1) | Viatech (1) | . . . | |

The candidate keywords are then sorted according to corresponding frequency values. The sorted result are:

Sorted Result

processor (6)
VIA (4)
1 GHz (3)
C3 (2)
Coolest (1)
Viatech (1)

Finally, keywords are selected from the candidate keywords according to the condition, and the selected keywords are registered into keyword database 204. If the condition indicates that a keyword must appear at least three (3) times (minimum) in the document, “processor”, “VIA”, and “1 GHz” are selected as keywords and registered into the keyword database 204. If the condition is top four (4) of ranking in the sorted result, “processor”, “VIA”, “1 GHz”, and “C3” are selected as keywords and registered into the keyword database 204.

According to another aspect, the system and method for keyword registration of the present invention can be encoded into computer instructions (computer-readable program code) and stored in the data recordable media (computer-readable storage media).

As a result, using the system and method for keyword registration according to the present invention, the keywords can be automatically registered, so as to save time and manpower in the parsing and registration process. Further, the synonyms can be recognized automatically to improve the accuracy of the parsing and registration process.

Although the present invention has been described in its preferred embodiments, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A system for keyword registration, comprising:
a data storage device having a symbol database, a function word database, and a keyword database; and
a processor to compare a document to the symbol and function word databases and delete symbols and function words from the document, calculate the frequency of each word in the document to acquire a plurality of candidate words and corresponding frequency values, select at least one keyword from the candidate words according to a condition, and register the selected keyword into the keyword database.

2. The system as claimed in claim 1 wherein the data storage device further includes a synonym database, and the processor further compares the document to the synonym database, to count, record, and delete synonyms from the document, and to store the synonyms and corresponding frequency values into a synonym register.

3. The system as claimed in claim 2 wherein the processor further integrates the synonyms and corresponding frequency values stored in the synonym register, and the candidate words and corresponding frequency values.

4. The system as claimed in claim 1 wherein the symbols and function words comprise elements incompatible with the keyword registration process.

5. The system as claimed in claim 1 wherein the condition is a predetermined minimum frequency, and the candidate keywords with corresponding frequency values larger than the minimum are selected as keywords and registered to the keyword database.

6. The system as claimed in claim 1 wherein the processor further sorts the candidate keywords according to corresponding frequency values.

7. The system as claimed in claim 6 wherein the condition is a predetermined minimum ranking value, and the candidate keywords above the minimum can be selected as keywords and registered to the keyword database.

8. A method for keyword registration, comprising the steps of:
receiving a document;
comparing the document to a symbol database and a function word database to delete symbols and function words from the document;
calculating the frequency of each word in the document to acquire a plurality of candidate words and corresponding frequency values;
selecting at least one keyword from the candidate words according to a condition; and
registering the at least one selected keyword into a keyword database.

9. The method as claimed in claim 8 further comprising the steps of:
comparing the document to a synonym database to count, record, and delete synonyms from the document, and;
storing the synonyms and corresponding frequency values into a synonym register.

10. The method as claimed in claim 9 further integrating the synonyms and corresponding frequency values stored in the synonym register, and the-candidate words and corresponding frequency values.

11. The method as claimed in claim 8 wherein the symbols and function words comprise elements incompatible with the keyword registration process.

12. The method as claimed in claim 8 wherein the condition is a predetermined minimum frequency, and the candidate keywords with corresponding frequency values larger than the minimum are selected as keywords and registered to the keyword database.

13. The method as claimed in claim 8 further sorting the candidate keywords according to corresponding frequency values.

14. The method as claimed in claim 9 wherein the condition is a predetermined minimum ranking value, and the candidate keywords above the minimum can be selected as keywords and registered to the keyword database.

15. A computer-readable storage medium having computer-readable program code embodied in the medium, the computer-readable program code comprising:
computer-readable program code for receiving a document;
computer-readable program code for comparing the document to a symbol database and a function word database to delete symbols and function words from the document;
computer-readable program code for calculating the frequency of each word in the document to acquire a plurality of candidate words and corresponding frequency values;
computer-readable program code for selecting at least one keyword from the candidate words according to a condition; and
computer-readable program code for registering the at least one selected keyword into a keyword database.

16. The computer-readable storage medium as claimed in claim 15 further comprising:
computer-readable program code for comparing the document to a synonym database to count, record, and delete synonyms from the document, and;
computer-readable program code for storing the synonyms and corresponding frequency values into a synonym register.

17. The computer-readable storage medium as claimed in claim 16 further comprising computer-readable program code for integrating the synonyms and corresponding frequency values stored in the synonym register, and the candidate words and corresponding frequency values.

18. The computer-readable storage medium as claimed in claim 15 wherein the condition is a predetermined minimum frequency, and the computer-readable storage medium further comprises computer-readable program code for selecting candidate keywords with corresponding frequency values larger than the minimum as keywords and registering the keywords to the keyword database.

19. The computer-readable storage medium as claimed in claim 15 further comprising computer-readable program code for sorting the candidate keywords according to corresponding frequency values.

20. The computer-readable storage medium as claimed in claim 19 wherein the condition is a predetermined minimum ranking value, and the computer-readable storage medium further comprises computer-readable program code for selecting the candidate keywords above the minimum as keywords and registering the keywords to the keyword database.
